(19) United States
(12) Patent Application Publication
(10) Pub. No.: US 2013/0031490 A1
(43) Pub. Date: Jan. 31, 2013

(54) ON-DEMAND TAB REHYDRATION

(71) Applicants: Young Kun Joo, Issaquah, WA (US); Jason R. Olson, Sammamish, WA (US); Vinay Kumar Venkatachalapathy, Seattle, WA (US); Maxim B. Oustiougov, Seattle, WA (US)

(72) Inventors: Young Kun Joo, Issaquah, WA (US); Jason R. Olson, Sammamish, WA (US); Vinay Kumar Venkatachalapathy, Seattle, WA (US); Maxim B. Oustiougov, Seattle, WA (US)

(73) Assignee: MICROSOFT CORPORATION, Redmond, WA (US)

(21) Appl. No.: 13/191,365

(22) Filed: Jul. 26, 2011

(51) Int. Cl. G06F 3/048

(52) U.S. Cl. 715/760

(57) ABSTRACT

Various embodiments proactively monitor and efficiently manage resource usage of individual tabs. In at least some embodiments, one or more tabs can be dehydrated in accordance with various operational parameters, and rehydrated when a user actually activates a particular tab. In at least some embodiments, rehydration can occur on a tab-by-tab basis, while at least some tabs remain dehydrated. Dehydrated tabs can, in some embodiments, be visually presented to a user in a manner in which normal, active tabs are presented.

### BACKGROUND

Web browsers can consume a large amount of system resources which can not only impact the user's Web browsing experience, but can also degrade the user's overall system experience. With the ability to open multiple tabs, it has become increasingly easier for users to unknowingly impact a system's performance by opening too many tabs and by not closing tabs that are no longer being used. Further, it is very difficult to control resource usage of each individual webpage that a user may browse to within a particular tab.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments proactively monitor and efficiently manage resource usage of individual tabs. In at least some embodiments, one or more tabs can be dehydrated in accordance with various operational parameters, and rehydrated when a user actually activates a particular tab. In at least some embodiments, rehydration can occur on a tab-by-tab basis, while at least some tabs remain dehydrated.

In at least some embodiments, dehydrated tabs are visually presented to a user in a manner in which normal, active tabs are presented. Thus, from a user experience standpoint, it appears that all tabs are active. In at least some embodiments, dehydrated tabs can have their associated state saved such that when a dehydrated tab is rehydrated, the state can be restored in a manner that is generally seamless from a user's perspective.

### BRIEF DESCRIPTION OF THE DRAWINGS

The detailed description is described with reference to the accompanying figures.

FIG. 1 is an illustration of an environment in an example implementation in accordance with one or more embodiments.

FIG. 2 is an illustration of a system in an example implementation showing FIG. 1 in greater detail.

FIG. 3 is a flow diagram that describes steps in a method in accordance with one or more embodiments.

FIG. 4 illustrates an example computing device in accordance with one or more embodiments.

FIG. 5 is a flow diagram that describes steps in a method in accordance with one or more embodiments.

FIG. 6 is a flow diagram that describes steps in a method in accordance with one or more embodiments.

FIG. 7 illustrates an example computing device that can be utilized to implement various embodiments described herein.

### DETAILED DESCRIPTION

Overview

Various embodiments proactively monitor and efficiently manage resource usage of individual tabs. In at least some embodiments, one or more tabs can be dehydrated in accordance with various operational parameters, and rehydrated when a user actually activates a particular tab. In at least some embodiments, rehydration can occur on a tab-by-tab basis, while at least some tabs remain dehydrated.

In at least some embodiments, dehydrated tabs are visually presented to a user in a manner in which normal, active tabs are presented. Thus, from a user experience standpoint, it appears that all tabs are active. In at least some embodiments, dehydrated tabs can have their associated state saved such that when a dehydrated tab is rehydrated, the state can be restored in a manner that is generally seamless from a user's perspective.

In the following discussion, an example environment is first described that is operable to employ the techniques described herein. Next, a section entitled “On-Demand Tab Rehydration” describes how tabs can be rehydrated on-demand in accordance with one or more embodiments. Following this, a section entitled “Dehydrated Tab Visualization” describes how dehydrated tabs can be visualized in accordance with one or more embodiments. Last, a section entitled “Example Device” describes aspects of an example device that can be utilized to implement one or more embodiments.

Having considered an overview of the embodiments about to be described, consider now a discussion of an example environment in which various embodiments can operate.

Example Environment

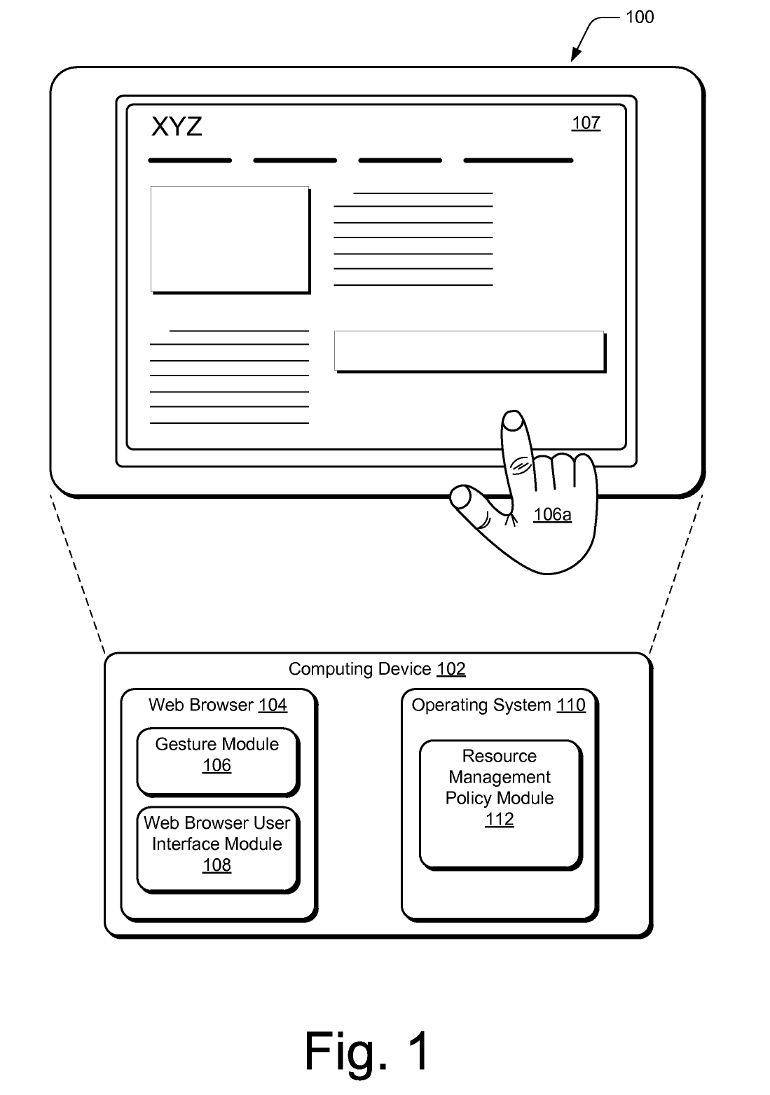

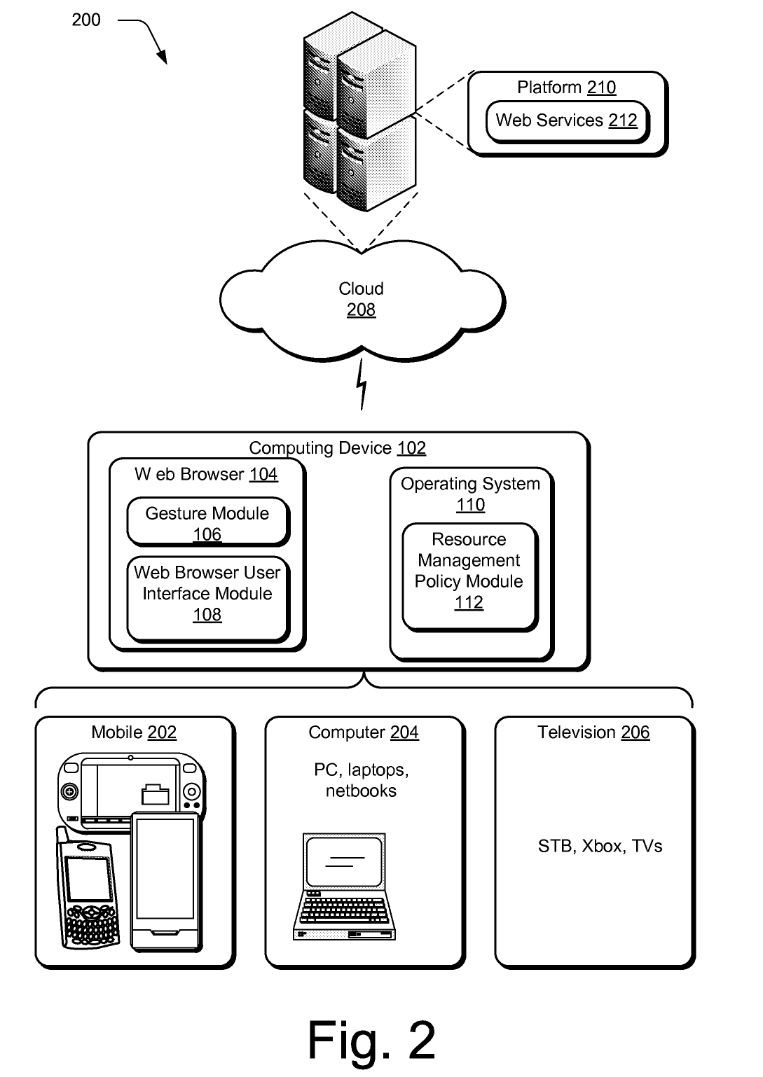

FIG. 1 is an illustration of an environment 100 in an example implementation that is operable to employ the techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. In one or more embodiments, the computing device is embodied as a slate-type or tablet-type form factor device that can typically be held by a user in one hand, and interacted with using the other hand.

Thus, the computing device 102 may range from full resource devices with substantial memory and processor resources (e.g., personal computers, game consoles, slate or tablet-form factor device) to a low-resource device with limited memory and/or processing resources (e.g., traditional set-top boxes, hand-held game consoles). The computing device 102 also includes software that causes the computing device 102 to perform one or more operations as described below.

Computing device 102 includes various applications including a web browser 104 that is operational to provide web browsing functionality as described in this document. The web browser can be implemented in connection with any suitable type of hardware, software, firmware or combination thereof. In at least some embodiments, the web browser is implemented in software that resides on some type of tangible, computer-readable medium examples of which are provided below.

Web browser 104 can include or otherwise make use of, in this example, a gesture module 106 and a web browser user interface module 108. The computing device also includes an operating system 110 that includes a resource management policy module 112.

Gesture module 106 is representative of functionality that can recognize a wide variety of gestures that can be employed in connection with web browsing activities. The gestures may be recognized by module 106 in a variety of different ways. For example, the gesture module 106 may be configured to recognize a touch input, such as a finger of a user's hand 106a as proximal to display device 107 of the computing device 102 using touch screen functionality. Alternately or additionally, the computing device 102 may be configured to detect and differentiate between a touch input (e.g., provided by one or more fingers of the user's hand 106a) and a stylus input provided by a stylus. The differentiation may be performed in a variety of ways, such as by detecting an amount of the display device 107 that is contacted by the finger of the user's hand 106a versus an amount of the display device 107 that is contacted by the stylus.

Thus, the gesture module 106 may support a variety of different gesture techniques through recognition and leverage of a division between stylus and touch inputs, as well as different types of touch inputs.

The web browser user interface module 108 is configured, in this particular example, to provide a web browser user interface that permits users to become more fully immersed in web page content that is displayed by the web browser. One or more embodiments emphasize a “content-over-chrome” approach that displays content in an efficient manner and manages display of browser instrumentalities, such as a tab band containing one or more tabs, to enable a user to more efficiently focus on a particular current user task.

The resource management policy module 112 of operating system 110 is responsible, at least in part, for overseeing efficient management of system resources. To this end, the resource management policy module 112 can oversee the operation of various applications, including web browser 104, and cause the applications to go into various states depending on, for example, the state of system resources.

For example, applications can be caused, by the resource management policy module 112, to go into a suspended state. This might be the case, for example, when an application is not the primary focus of a user's present activity, such as by being placed in the background. In the suspended state, the application may still reside in memory and may still remain open. However, the application may not receive CPU cycles while in the suspended state. When an application is to assume the suspended state, the operating system or, in this case, the resource management policy module 112, may call the application to inform it that it is to assume a suspended state. Responsive to receiving this call (or at other times such as periodically), the application can take steps to save various state information so that if it is closed or terminated, when it becomes active again, it can resume operation in the pre-terminated state.

Additionally, as alluded to above, applications can be caused, by the resource management policy module 112, to go into a terminated state. In one or more embodiments, a terminated state follows a suspended state. In a terminated state, the operating system causes the application to be closed. The terminated state might be caused for a number of reasons including, by way of example and not limitation, a period of inactivity with respect to a particular application, system resource pressure, and the like. Now, when a user returns to a terminated application, the application is started and the state information that was previously saved is read and used to return the application the back into its pre-termination state.

In the Web browser context, when the Web browser receives an indication that it is to be suspended, it can save various state information associated with its current operation before it is suspended. This state information can be saved on a tab-by-tab basis and can include, by way of example and not limitation, a URL associated with a particular tab, a travel log associated with the tabs, which tabs are open, which tab is currently active, form data, scroll state/position, zoom level, state of media playback, and the like. In the context of this document, dehydration refers to the notion of saving state information associated with a particular tab or tabs. Dehydration can occur periodically or in response to some event, such as receiving a notification that the web browser is to be suspended or by being placed in the background.

In one or more embodiment, as part of tab dehydration, a tab's title and a thumbnail image associated with the tab can be saved to disk. The thumbnail image can comprise any type of image such as an icon associated with a tab's content or a thumbnail image of the tab's web page. If the Web browser is now terminated by being placed in the terminated state, relevant state information has been preserved to enable the tabs to be rehydrated. Specifically, assume that a user returns to the terminated web browser. The state information can be used to place the web browser in its pre-terminated state by first activating the current tab, and then activating subsequent tabs when a user selects the subsequent tab or tabs.

FIG. 2 illustrates an example system 200 showing the web browser 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size or form factor and thus the computing device 102 may be configured as one of these device classes in this example system 200. For instance, the computing device 102 may assume the mobile 202 class of device which includes mobile telephones, music players, game devices, slate-type or tablet-type form factor devices and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the gesture module 106 may be detected using touch screen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

On-Demand Tab Rehydration

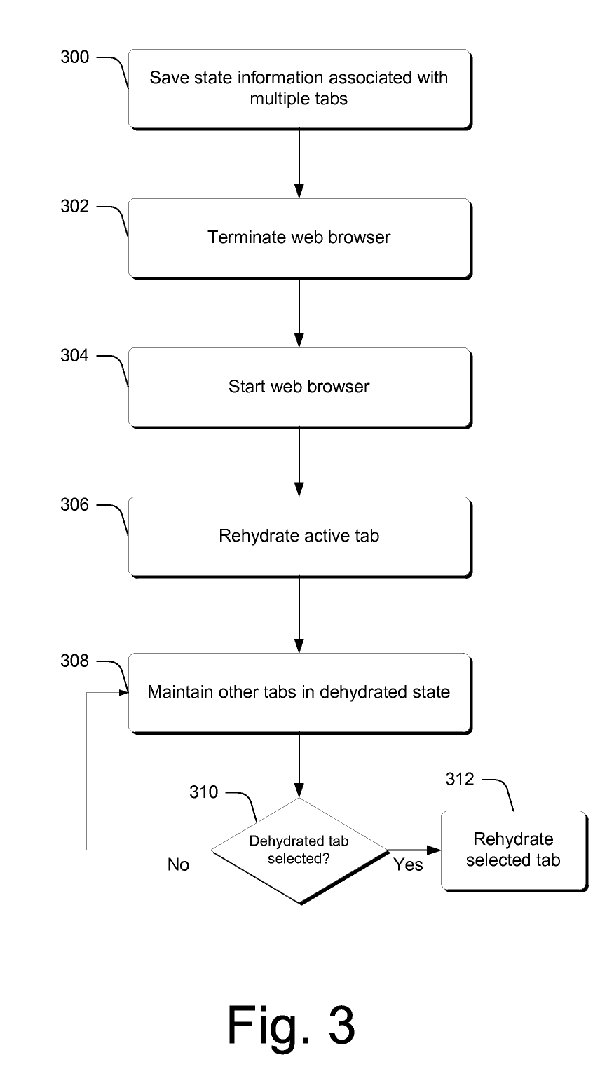

FIG. 3 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 300 saves state information associated with multiple tabs. This step can be performed in any suitable way. For example, this step can be performed periodically. Alternately or additionally, this step can be performed responsive to the web browser being informed that it is to go into a suspended state or otherwise being caused to go into a suspended state. Step 302 terminates or otherwise causes the web browser to be terminated. Step 304 starts the Web browser. This step can be performed in any suitable way. For example, this step can be performed responsive to detecting a user's attempt to return to the Web browser. Part of accomplishing this step can include, by way of example and not limitation, using at least some of the state information that was saved at step 302 to return the Web browser to its previous state. Accordingly, step 306 were rehydrates a tab that was active when the Web browser was terminated. This can include, by way of example and not limitation, initiating a process associated with the active tab and causing a navigation to an associated URL. Step 308 maintains other tabs in a dehydrated state. In the dehydrated state, a particular tab does not have a process in which to run. However, dehydrated tabs can have associated visualizations that are selectable by a user. Step 310 ascertains whether a dehydrated tab has been selected by a user. If not, the method returns to step 308 and maintains the tabs in the dehydrated state. If, on the other hand, a dehydrated tab has been selected, step 312 rehydrates the selected tab. In one or more embodiments, when a tab is rehydrated, an associated process can be initiated and a navigation to the rehydrated tab's associated URL can occur. In one or more embodiment, this can occur in less than one second. Thus, tab rehydration can occur in a seamless manner that is generally transparent to the user. At this point, if there are more dehydrated tabs, the method can return to step 308.

Thus, tabs are rehydrated in an on-demand fashion, thus conserving system resources and reducing the system impact of rehydrating multiple tabs concurrently. Having considered on-demand rehydration, consider now the notion of dehydrated tab visualization.

Dehydrated Tab Visualization

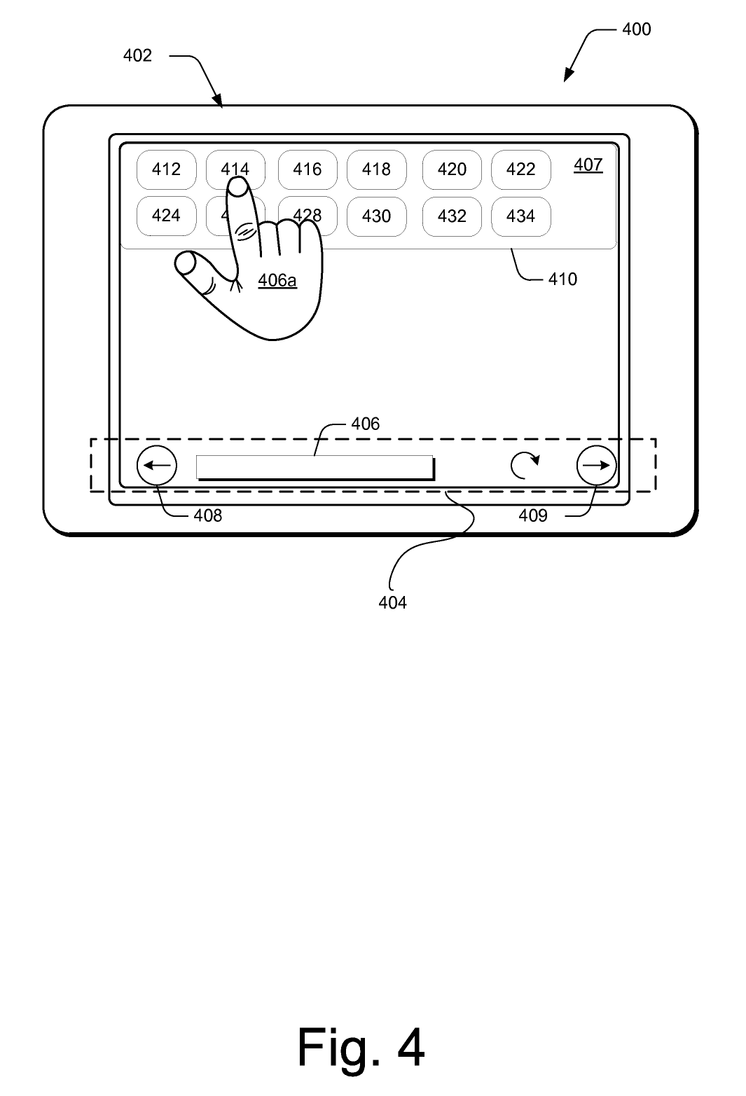

As noted above, in at least some embodiments, dehydrated tabs can be visually presented to a user in a manner in which normal, active tabs are presented. Thus, from a user experience standpoint, it appears that all tabs are active when, in fact, less than all of the tabs may be active. As an example, consider FIG. 4.

Assume in this example, that the web browser has been suspended and subsequently terminated as described above. Assume also that the user has returned to the web browser, thus causing the web browser to be restarted and for the active tab to be returned to its pre-termination state. For example, an example environment 400 includes a computing device 402 in accordance with one or more embodiments. Computing device 402 includes a display device 407 having a region 404 at the bottom of the display device, and various navigation and other instrumentalities that have been invoked and visually displayed. Specifically, the instrumentalities include an address bar 406, back button 408, and forward button 409.

In this example, a tab band 410 appears at the top of display device 407 and includes multiple tabs 412-434. In this particular example, assume that the active tab prior to termination was tab 412. Accordingly, when the web browser is restarted, the state information associated with tab 412 can be used to rehydrate the tab. The other tabs—such as tabs 414-434 can remain dehydrated. However, to provide a user experience that makes it appear like the dehydrated tabs are rehydrated, dehydrated tabs can have their own visualization. For example, in at least some embodiments, tabs that remain dehydrated can have a visualization within tab band 410 that includes a title and a thumbnail image.

Assume now that a user's hand 406a tap-engages tab 414. In this instance, tab 414 can be rehydrated. To do so, the Web browser can initiate a process associated with tab 414, and use the tab's state information to cause navigation to an associated URL, at which point tab 414 can now become the active tab. In this particular example, two tabs—tabs 412, 414 have been rehydrated while tabs 416-434 remain dehydrated.

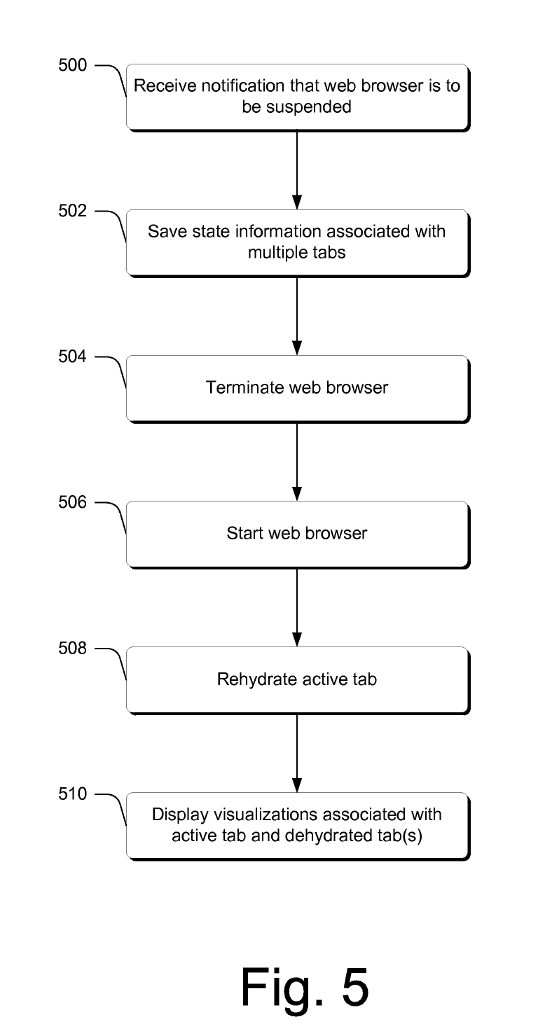

FIG. 5 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 500 receives notification that a web browser is to be suspended. This step can be performed in any suitable way. For example, this step can be performed by the web browser receiving a notification from the system's operating system that it is to be suspended. Responsive to receiving this notification, step 502 saves state information associated with multiple tabs. Examples of types of state information that can be saved are provided above. Step 504 terminates or otherwise causes the web browser to be terminated. Step 506 starts the Web browser. This step can be performed in any suitable way. For example, this step can be performed responsive to detecting a user's attempt to return to the Web browser. Part of accomplishing this step can include, by way of example and not limitation, using at least some of the state information that was saved at step 502 to return the Web browser to its previous state. Accordingly, step 508 rehydrates a tab that was active when the Web browser was terminated. This can include, by way of example and not limitation, initiating a process associated with the active tab and causing a navigation to an associated URL. Step 510 displays visualizations associated with the active tab and any dehydrated tabs. This step can be performed in any suitable way. In one or more embodiments, this step can be performed by displaying visualizations associated with the dehydrated tabs that are of the same or similar type as that of any active tabs. In this manner, dehydrated tabs appear, to the user, as if they are fully functioning active tabs. Any suitable type of visualization can be utilized. In one or more embodiments, the visualization can include a title that can be either displayed within the tab or slightly below the tab and/or a thumbnail image that appears within the tab.

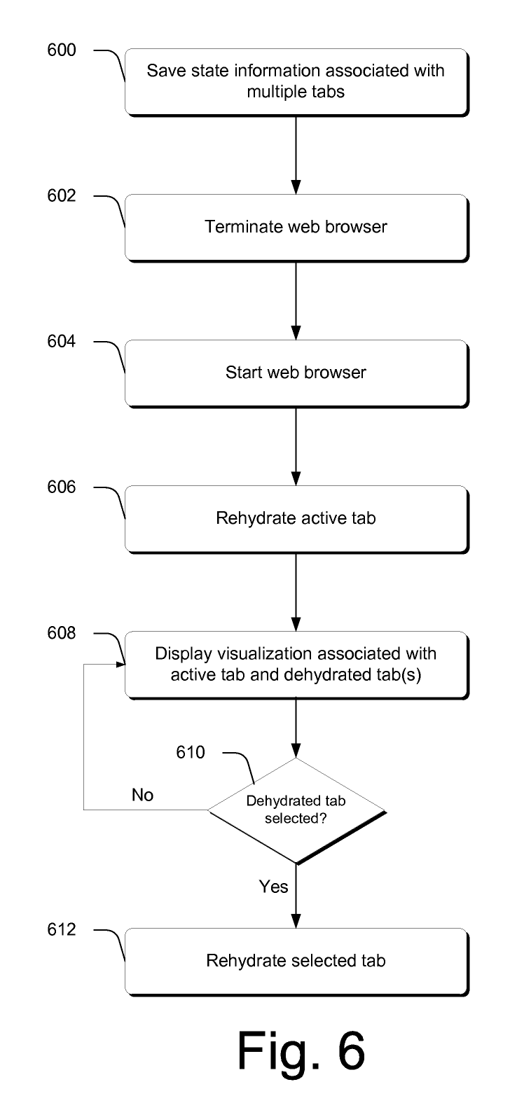

FIG. 6 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 600 saves state information associated with multiple tabs. This step can be performed in any suitable way. For example, this step can be performed periodically or responsive to some event. For example, one type of event might be notification of an intent to cause an associated Web browser to enter into a suspended state. Examples of types of state information that can be saved are provided above. Step 602 terminates or otherwise causes the web browser to be terminated. Step 604 starts the Web browser. This step can be performed in any suitable way. For example, this step can be performed responsive to detecting a user's attempt to return to the Web browser. Part of accomplishing this step can include, by way of example and not limitation, using at least some of the state information that was saved at step 600 to return the Web browser to its previous state. Accordingly, step 606 rehydrates a tab that was active when the Web browser was terminated. This can include, by way of example and not limitation, initiating a process associated with the active tab and causing a navigation to an associated URL. Step 608 displays visualizations associated with the active tab and any dehydrated tabs. This step can be performed in any suitable way. In one or more embodiments, this step can be performed by displaying visualizations associated with the dehydrated tabs that are of the same or similar type as that of any active tabs. In this manner, dehydrated tabs appear, to the user, as if they are fully functioning active tabs. Any suitable type of visualization can be utilized. In one or more embodiments, the visualization can include a title that can be either displayed within the tab or slightly below the tab and/or a thumbnail image that appears within the tab. Step 610 ascertains whether a dehydrated tab has been selected by a user. This step can occur in any suitable way such as, by way of example and not limitation, ascertaining that a user has selected a particular tab as by providing input, such as touch or other type of input. If a dehydrated tab has not been selected, the method can return to step 608 and continue to display the visualizations. If, on the other hand, a dehydrated tab has been selected, step 612 rehydrates the selected tab. Examples of how a tab can be rehydrated are provided above. The method can then return to step 608.

Having described various example embodiments, consider now a discussion of an example device that can be utilized to implement one or more embodiments.

Example Device

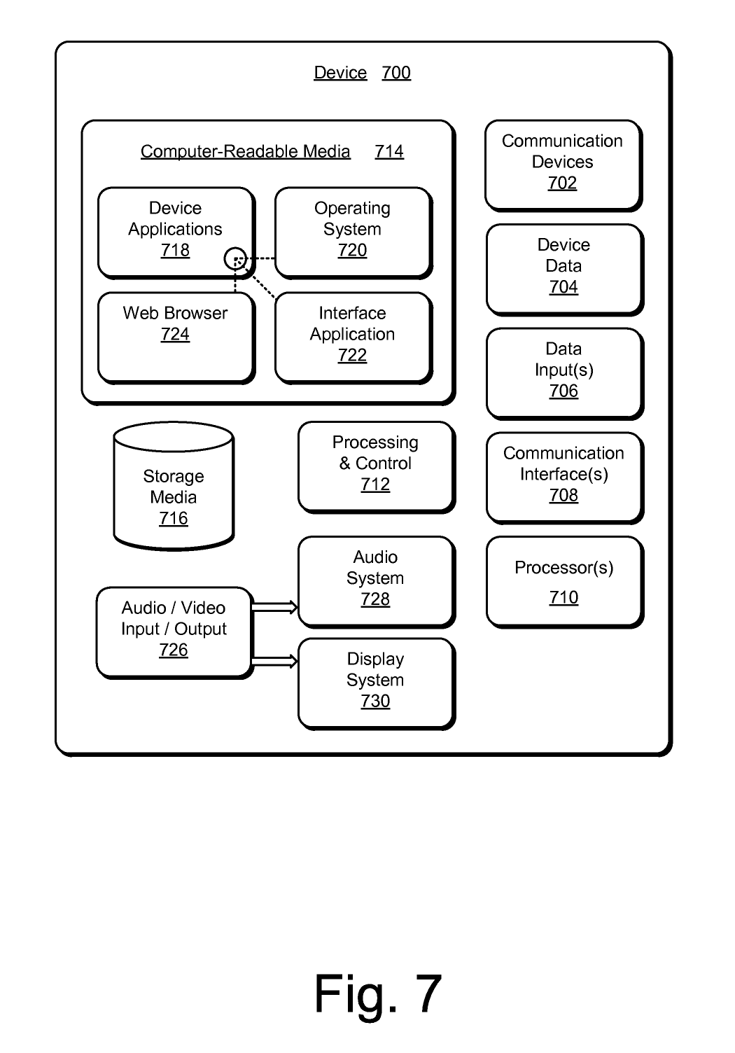

FIG. 7 illustrates various components of an example device 700 that can be implemented as any type of portable and/or computer device as described with reference to FIGS. 1 and 2 to implement the embodiments described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the on-demand tab rehydration embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the on-demand tab rehydration techniques described herein. In this example, the device applications 718 include an interface application 722 and a web browser 724 that are shown as software modules and/or computer applications. The web browser 724 is representative of software that is used to provide web browsing functionality, including an interface with a device configured to capture gestures, such as a touch screen, track pad, camera, and so on.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

Conclusion

Various embodiments proactively monitor and efficiently manage resource usage of individual tabs. In at least some embodiments, one or more tabs can be dehydrated in accordance with various operational parameters, and rehydrated when a user actually activates a particular tab. In at least some embodiments, rehydration can occur on a tab-by-tab basis, while at least some tabs remain dehydrated.

In at least some embodiments, dehydrated tabs are visually presented to a user in a manner in which normal, active tabs are presented. Thus, from a user experience standpoint, it appears that all tabs are active. In at least some embodiments, dehydrated tabs can have their associated state saved such that when a dehydrated tab is rehydrated, the state can be restored in a manner that is generally seamless from a user's perspective.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
saving state information associated with multiple tabs of a web browser;
terminating the Web browser;
starting the Web browser;
rehydrating a tab that was active when the Web browser was terminated;
maintaining at least one other tab in a dehydrated state;
ascertaining whether said at least one other tab has been selected by a user; and
responsive to said at least one other tab being selected, rehydrating said at least one other tab.

2. The computer-implemented method of claim 1, wherein said saving is performed periodically.

3. The computer-implemented method of claim 1, wherein said saving is performed responsive to the web browser being caused to go into a suspended state.

4. The computer-implemented method of claim 1, wherein the state information comprises one or more of: a URL associated with a particular tab, a travel log associated with the tabs, which tab is currently active, form data, scroll state/position, zoom level, or state of media playback.

5. The computer-implemented method of claim 1 further comprising visually presenting said at least one other tab in a manner in which active tabs are presented.

6. The computer-implemented method of claim 1 further comprising visually presenting said at least one other tab in a manner in which active tabs are presented, wherein said visually presenting comprises visually presenting a title and a thumbnail image associated with said at least one other tab.

7. The computer-implemented method of claim 1, wherein said ascertaining comprises ascertaining whether said at least one other tab has been selected via touch input.

8. One or more computer readable storage media embodying computer readable instructions which, when executed, implement a method comprising:
receiving a notification that a Web browser is to be suspended;
responsive to receiving the notification, saving state information associated with multiple tabs of the Web browser;
responsive to the Web browser returning from a terminated state, displaying one or more visualizations associated with one or more respective dehydrated tabs, the one or more visualizations being the same or similar type as that of visualizations associated with an active tab.

9. The one or more computer readable storage media of claim 8, wherein the state information comprises one or more of: a URL associated with a particular tab, a travel log associated with the tabs, which tab is currently active, form data, scroll state/position, zoom level, or state of media playback.

10. The one or more computer readable storage media of claim 8, further comprising rehydrating a tab that was active prior to the Web browser entering in the terminated state.

11. The one or more computer readable storage media of claim 8 further comprising rehydrating one or more dehydrated tabs on demand.

12. The one or more computer readable storage media of claim 8, wherein said displaying one or more visualizations comprises displaying a title and a thumbnail image associated with dehydrated tabs.

13. A system comprising:
one or more computer readable storage media;
a web browser embodied on the one or more computer readable storage media and configured to implement a method comprising:
receiving a notification that the web browser is to be suspended;
responsive to receiving the notification, saving state information associated with multiple tabs of the web browser;
responsive to the web browser returning from a terminated state, displaying one or more visualizations associated with one or more respective dehydrated tabs, the one or more visualizations being the same or similar type as that of visualizations associated with an active tab.

14. The system of claim 13, wherein the state information comprises one or more of: a URL associated with a particular tab, a travel log associated with the tabs, which tab is currently active, form data, scroll state/position, zoom level, or state of media playback.

15. The system of claim 13, wherein the web browser is configured to implement a method further comprising rehydrating a tab that was active prior to the Web browser entering the terminated state.

16. The system of claim 13, wherein the web browser is configured to implement a method further comprising rehydrating one or more dehydrated tabs on demand.

17. The system of claim 13, wherein the web browser is configured to implement a method further comprising ascertaining whether a dehydrated tab has been selected by a user via touch input; and responsive to a dehydrated tab being selected via touch input, rehydrating the selected dehydrated tab.

18. The system of claim 13, wherein said displaying one or more visualizations comprises displaying a title and a thumbnail image associated with dehydrated tabs.

19. A computing device embodying the system of claim 13.

20. A tablet computing device embodying the system of claim 13.
